(19) United States
(12) Patent Application Publication
(10) Pub. No.: US 2012/0254453 A1
(43) Pub. Date: Oct. 4, 2012

(54) REMOTE USER INTERFACE ADAPTER

(75) Inventors: Stephane Lejeune, San Diego, CA (US); Graham Clift, El Cajon, CA (US); James Amendolagine, San Marcos, CA (US)

(73) Assignee: SONY CORPORATION, Tokyo (JP)

(21) Appl. No.: 13/073,718

(22) Filed: Mar. 28, 2011

(51) Int. Cl. G06F 15/16

(52) U.S. Cl. 709/230

(57) ABSTRACT

An adapter is a device to transcode or translate different graphics languages to permit a variety of networked, dissimilar devices, to communicate by partially rendering or translating an existing application's devices' graphics/images into a lower level Remote User Interface (Remote UI or RUI) graphics protocol; the RUI graphics protocol delivered over the network to a rendering device.

### FIELD OF THE INVENTION

The present invention relates to the field of user interfaces. More specifically, the present invention relates to a Remote User Interface (Remote UI) adapter for enabling devices with disparate protocols to communicate.

### BACKGROUND OF THE INVENTION

The number of electronic devices in people's homes is continually increasing. Many years ago, homes only had a radio; then, a radio and a television. The number of devices has increased to the point where a typical home has several televisions, stereos, computers, video game consoles, mobile phones/devices, appliances and others. Furthermore, these devices are gaining intelligence so that they are able to communicate with each other.

The expansion of residential networks to include a multiplicity of devices that can share files asynchronously and connect to the Internet through residential gateways was facilitated by the de-facto standard use of wired and wireless ethernet connectivity. Asynchronous sharing then started to give way to buffered streaming of video as bandwidth availability improved. This was closely followed by real time streaming. Networks employ quality of service to manage bandwidth resources and Universal Plug and Play (UPnP) to perform discovery and compatibility of compressed video content. Video UPnP also defines remote user input operation like play, stop and rewind so that video control as well as video display is able to be performed remotely. Also, provisions were made to support graphical transfer of a remote user interface, but no implementations on the market have made use of this. UPnP allowed for many different standards of compressed video, but does not, however, certify that a client supported the relevant decoder. Digital Living Network Alliance (DLNA) is a standards body formed to provide certified device compatibility for a specific subset of UPnP implementations. DLNA also defined the role of media servers, renderers, adapters, players and controllers.

A standard, referred to as Remote User Interface (RUI or Remote UI) is being developed to allow devices to operate each other and provide the user with a user interface that is configured appropriately for a device being used to control another device. For example, a user interface for a 46″ wide television is not likely to appear properly on a mobile phone which has a display of 2″. The Remote UI standard is a web-based protocol and framework for remote user interface on UPnP Networks and the Internet. The standard allows a UPnP-capable home network device to provide its interface (display and control options) as a web page to display on any other device coupled to the home network.

There are no well defined and widely accepted UPnP implementations for graphical RUI. One option, which has been backed by the UPnP Forum, is a browser based implementation known as CEA2014. The network client browser is considered to be heavy in flash, memory and/or processor requirements (‘thick’ client), whereas the network server application performs simple encapsulation of XML (‘thin’ server). In some situations this may be acceptable, like the case when rendering is performed by a personal computer and the application is run on a small mobile device, or a low end processing device, like a network router.

However, in the case of the home network where the rendering is done by a high definition TV, a Blu-Ray® player, a picture frame or a gaming machine, the use of a browser for RUI has some disadvantages. Firstly, a browser adds to the already substantial memory requirements of the renderers and so for these cost sensitive consumer electronics devices it may not be viable. Secondly, the processing speed requirements for a responsive experience are not going to be provided by the current range of devices available. And thirdly, the browser interface lends itself well to mouse and keyboard control, but is not necessarily the ideal format for a limited button remote control.

Also, the home network is able to include graphics applications built into game machines, video players, dongles and intelligent remotes on the low end, with cable boxes, cloud servers and multimedia PCs on the high end. To shoehorn all of these into one UPnP standard, it is clear that reach will be limited. In some cases substantial effort of rewriting or translation of the graphics application might be needed in order to fit the browser framework.

Another example of a proposed RUI is being provided through the RVU alliance. The RVU alliance was initiated by DirectTV in order to provide a pixel accurate remotely rendered version of their satellite decoder user interface. Unlike the browser based RUI, RVU uses a low level protocol that manipulates the graphics card framebuffer layers more directly. Instead of the script type messages that CEA2014 uses, RVU breaks up elements of the graphics into images that can be sent compressed or uncompressed over the network to be composited in the renderers screen buffers or off screen buffers as needed. Simple bit commands are sent over the network to allow the images to be stretched, cut and alpha-blended on the renderer side. This type of RUI would be considered a thin network client and thick network server because most of the computation effort would be with the application. Also, because most actions involve sending image data, this type of RUI uses a lot of network resources.

The advantage of RVU is that the low level graphics operations are able to be supported by all graphics cards quite easily and is not directly dependent on the type of application to be able to function. However, sometimes performance is a key parameter in usability, and as such the network load and network server performance could severely limit how useful the protocol is. RVU is especially vulnerable where complete screen refreshes are needed often, like 3D rotations of a view. A browser approach could handle this more simply through scripts of simple rotation commands. Another similar limitation is when the application is providing remote graphics to multiple renderers, and causes the application processor to run short of the necessary MIPS to perform adequately.

Therefore, of these options described, none is optimal.

### SUMMARY OF THE INVENTION

An adapter is a device to transcode or translate different graphics languages to permit a variety of networked, dissimilar devices, to communicate by partially rendering or translating an existing application's devices' graphics/images into a lower level Remote User Interface (Remote UI or RUI) graphics protocol; the RUI graphics protocol delivered over the network to a rendering device.

In one aspect, an adapter comprises a memory for storing an application, the application for determining remote user interface protocols implemented on devices within a network enabling the devices to communicate using the remote user interface protocols and a processing component coupled to the memory, the processing component for processing the application. The application implements the remote user interface protocols. The processor processes additional data received from at least one of the devices within the network. At least two of the devices implement disparate remote user interface protocols. The adapter is discoverable by the devices. Discovering occurs by Universal Plug and Play. The application is incorporated as a middleware layer. The application receives a command in a first remote user interface protocol and sends the command in a second remote user interface protocol. The adapter is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

In another aspect, a method of implementing an adapter comprises discovering devices in a network, determining a remote user interface protocol for each of the devices and enabling the devices to communicate using the remote user interface protocols. The method further comprises performing additional processing to lessen a processing load on at least one of the devices in the network. Enabling further comprises translating a command in a first remote user interface protocol into the command in a second remote user interface protocol. Translating further comprises receiving a command in the first remote user interface protocol and sending the command in the second remote user interface protocol. The first remote user interface protocol is different from the second remote user interface protocol.

In another aspect, a network of devices comprises a first device implementing a first remote user interface protocol, a second device implementing a second remote user interface protocol and an adapter device capable of communicating in the first remote user interface protocol and the second remote user interface protocol for converting commands received in the first user interface protocol to the second user interface protocol. The first device is a gateway device and the second device is a rendering device. The adapter device receives the commands in the first remote user interface protocol from the first device and communicates the commands in the second remote user interface protocol to the second device. The first protocol and the second protocol are disparate protocols.

In yet another aspect, a system programmed in a controller in a device comprises a discovering module for discovering devices in a network, a determining module for determining a remote user interface protocol implemented by each of the devices and an adapting module for translating a command in a first remote user interface protocol to the command in a second remote user interface protocol. The devices are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

### BRIEF DESCRIPTION OF THE DRAWINGS

FIG. 1 illustrates a network of devices including an adapter for implementing an RUI according to some embodiments.

FIG. 2 illustrates a flowchart of a method of utilizing an RUI adapter according to some embodiments.

FIG. 3 illustrates a block diagram of an exemplary adapter computing device according to some embodiments.

### DETAILED DESCRIPTION OF THE PREFERRED EMBODIMENT

Devices with incompatible Remote User Interface (Remote UI or RUI) protocols are generally not able to be used for remote rendering without a means for the devices to communicate. This limits the usefulness of the RUI devices on a network.

An adapter is a device to transcode or translate different graphics languages to permit a variety of networked, dissimilar devices, to communicate by partially rendering or translating an existing application's devices' graphics/images into a lower level RUI graphics protocol; where the RUI graphics protocol is delivered over the network to a rendering device (e.g. a PC with X11 and a television with 2014). The adapter is discoverable.

A method of translating incompatible RUI protocols to allow RUI rendering to take place between incompatible RUI devices is also described. An RUI translator is provided that is able to convert one type of RUI protocol or one graphics API to another. With the RUI translator, two RUI devices which are incompatible are able to become compatible. For example, conversions are able to be an X11 to directfb/voodoo protocol, OpenVG to OpenGL or any other appropriate conversion.

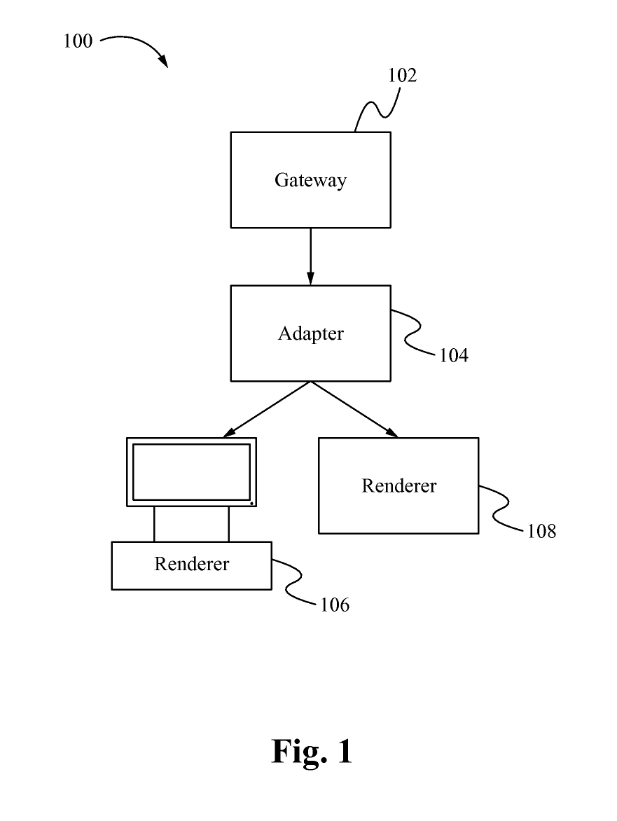

FIG. 1 illustrates a network of devices 100 including an adapter for implementing an RUI according to some embodiments. A gateway device 102, an adapter device 104, a first rendering device 106 and a second rendering device 108 are operatively coupled together. In some embodiments, the devices are coupled using wires, wirelessly or a combination thereof.

The gateway device 102 is any device which is able to be used as a gateway to couple many devices, for example, in the home. Gateway devices are able to combine DSL/cable modem capabilities, switching capabilities and other networking capabilities. Gateway devices are also able to be a link to a larger network such as the Internet.

The first rendering device 106 (e.g. a television) and the second rendering device (e.g. a Blu-ray® player) 108 are any devices that render data for the purpose of displaying the data.

The adapter device 104 is any device which is able to implement middleware such as a Blu-ray® disc Java stack. Additionally, the adapter device 104 provides an adapter implementation which communicates in many different RUI protocols and interfaces. For example, the adapter device 104 is able to receive a command in one RUI protocol and then output the command in a second RUI protocol so that a device that communicates based on the second RUI protocol is able to understand the command. As a further example, if the gateway device 102 attempts to send a command to the first rendering device 106, but the gateway device 102 communicates using a protocol of graphics commands based on OpenVG and the first rendering device 106 only accepts a protocol of graphics commands based on OpenGL, then, typically, the devices would not be able to communicate. However, with the adapter device 104, the gateway device 102 sends the OpenVG protocol command to the adapter device 104 which translates an OpenGL protocol command and sends this OpenGL protocol command to the first rendering device 106 which is able to process it. Although a protocol command is described herein, any information is able to be sent, translated and then re-sent. In some embodiments, the adapter device 104 is able to perform rendering processing or other processing to help with the processing load on the network.

In some embodiments, the network of devices 100 includes a network. The network is able to be any type of network such as a Local Area Network (LAN), a Wide Area Network (WAN), the Internet, a network of networks or any other network. Additionally, the type of network is able to be wireless, wired, cellular, any other type of network or any combination of two or more networks.

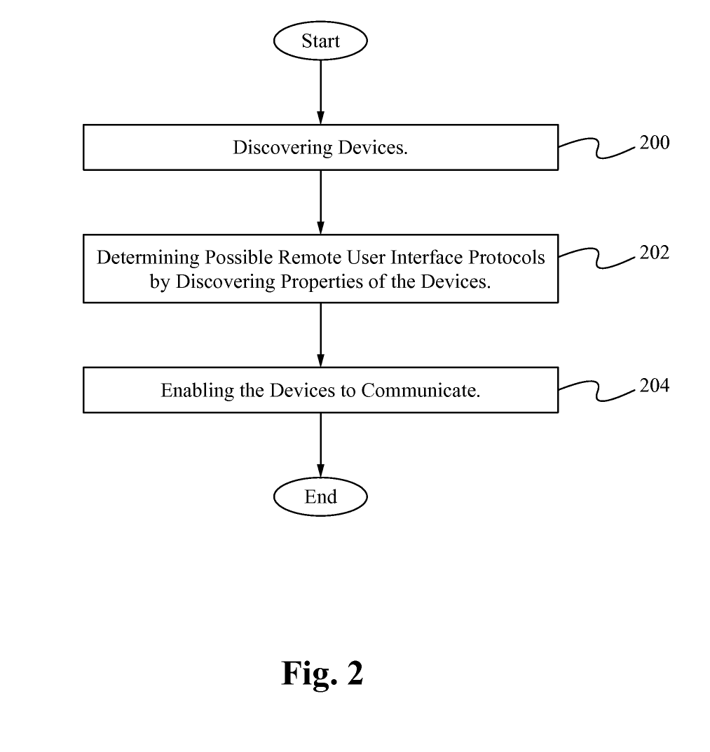

FIG. 2 illustrates a flowchart of a method of utilizing a remote user interface adapter according to some embodiments. In the step 200, devices are discovered by an adapter device. For example, an adapter device discovers a remote renderer device by extended UPnP or other discovery mechanism. In some embodiments, the device is known by the adapter device, and the step 200 is able to be skipped. In the step 202, properties discovered about the devices are analyzed by the adapter device, and RUI protocols are determined. In the step 204, the devices are able to communicate via the adapter device. For example, a gateway device and a renderer device which communicate using different RUI protocols are able to communicate where the gateway device provides commands in a first RUI protocol and the renderer device receives commands in a second RUI protocol. In some embodiments, the adapter also performs processing to lessen a processing load of a device in the network. For example, if a game for a gaming console has heavy video processing requirements, some of the processing is able to be performed on the adapter. Although specific steps are described, in some embodiments, fewer or more steps are included, and/or the order of the steps is able to be changed.

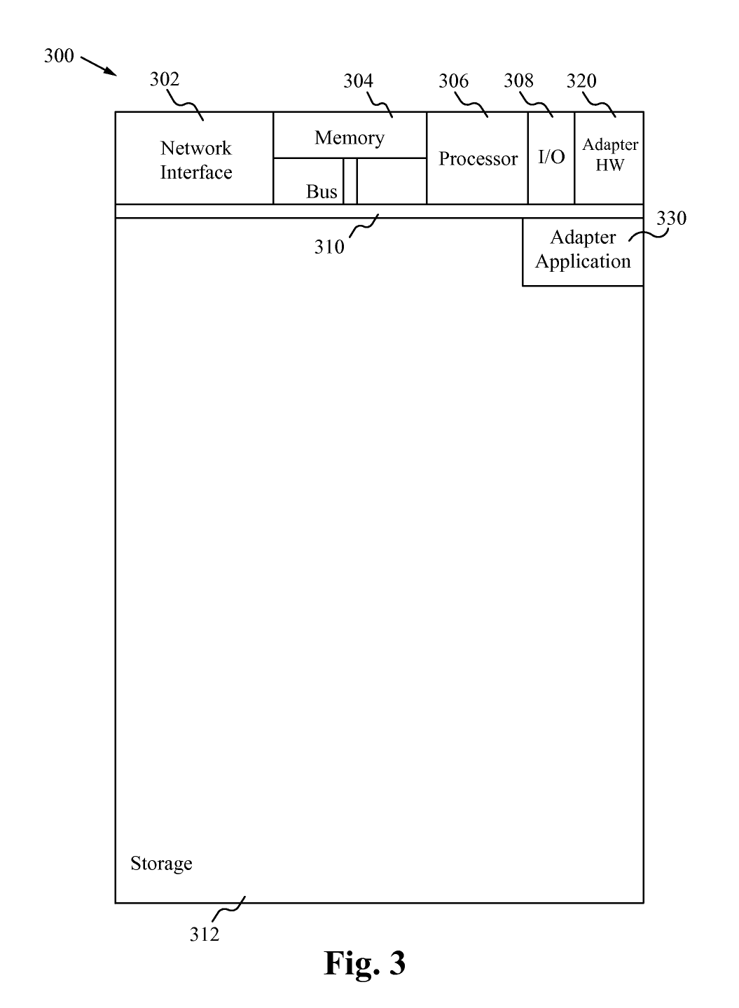

FIG. 3 illustrates a block diagram of an exemplary adapter computing device 300 according to some embodiments. The computing device 300 is able to be used to acquire, store, compute, communicate and/or display information. For example, the computing device 300 is able to acquire, store, translate and implement commands in disparate protocols. For example, the computing device 300 receives a command from a device in a first protocol and sends the command in a second protocol to another device that utilizes the second protocol. Although, the adapter translating commands is a possible implementation, the adapter is also able to receive, process and send commands in the same protocol (e.g. when two devices implement the same protocol). The computing device 300 is also able to provide additional processing power to assist in other devices' processing. In general, a hardware structure suitable for implementing the computing device 300 includes a network interface 302, a memory 304, a processor 306, I/O device(s) 308, a bus 310 and a storage device 312. The choice of processor is not critical as long as a suitable processor with sufficient speed is chosen. The memory 304 is able to be any conventional computer memory known in the art. The storage device 312 is able to include a hard drive, CDROM, CDRW, DVD, DVDRW, Blu-ray®, flash memory card or any other storage device. The computing device 300 is able to include one or more network interfaces 302. An example of a network interface includes a network card connected to an Ethernet or other type of LAN. The I/O device(s) 308 are able to include one or more of the following: keyboard, mouse, monitor, display, printer, modem, touchscreen, button interface and other devices. Remote user interface adapter application(s) 330 used to perform the remote user interface adapter operations are likely to be stored in the storage device 312 and memory 304 and processed as applications are typically processed. More or less components shown in FIG. 3 are able to be included in the computing device 300. In some embodiments, remote user interface adapter hardware 320 is included. Although the computing device 300 in FIG. 3 includes applications 330 and hardware 320, the remote user interface adapter operations are able to be implemented on a computing device in hardware, firmware, software or any combination thereof. For example, in some embodiments, the remote user interface adapter applications 330 are programmed in a memory and executed using a processor. In another example, in some embodiments, the remote user interface adapter hardware 320 is programmed hardware logic including gates specifically designed to implement the remote user interface adapter operations.

In some embodiments, the remote user interface adapter application(s) 330 include several applications and/or modules. As described herein, a discovering module for discovering devices, a determining module for determining properties of the devices such as protocols implemented on the devices and an adapter/translation module for enabling the devices to communicate with each other even when the devices implement disparate protocols. In some embodiments, modules include one or more sub-modules as well. In some embodiments, fewer or additional modules are able to be included.

Examples of suitable computing devices include a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPod®/iPhone, a video player, a DVD writer/player, a Blu-ray® writer/player, a television, a home entertainment system or any other suitable computing device. In some embodiments, a computing device is able to include intelligent appliances such as a refrigerator, a toaster, a toaster oven and a microwave, where the appliances are able to process and/or present information.

To utilize the RUI adapter, a user incorporates the adapter in a network by coupling the adapter to the devices in the network. The coupling is able to be wired, wireless or a combination thereof. Depending on the implementation, the adapter determines the protocols implemented by the devices on the network and performs the adapting (also referred to as translating) from one protocol to another, so that commands are able to be transmitted/received by devices with similar or disparate protocols. The determining and adapting is able to occur automatically or manually depending on the implementation. Although it has been generally described that a command is translated into another protocol, the command is able to be translated into several protocols. For example, if a user wants to turn on many devices, but each device implements a different RUI protocol than a controlling device, the adapter is able to translate the command into many different protocols at the same time so that the devices all turn on. From a user's perspective, the user generally does not notice that the adapter is functioning aside from disparate devices being able to communicate and devices functioning more efficiently with the processor load being shared with the adapter.

In operation, the adapter determines protocols implemented by devices being communicated with. If the devices implement the same protocol, then the adapter passes any communications sent from one device to the other device. However, if the devices implement disparate protocols, the adapter is able to translate from one protocol to another so that the devices are able to communicate. The adapter is also able to process commands or perform computations to lighten a processing load of another device such as a rendering device.

The devices implemented within the network described herein are able to implement Digital Living Network Alliance (DLNA) standard as well.

### SOME EMBODIMENTS OF REMOTE USER INTERFACE ADAPTER

1. An adapter comprising:
a. a memory for storing an application, the application for:
   i. determining remote user interface protocols implemented on devices within a network;
   ii. enabling the devices to communicate using the remote user interface protocols; and
b. a processing component coupled to the memory, the processing component for processing the application.

2. The adapter of clause 1 wherein the application implements the remote user interface protocols.

3. The adapter of clause 1 wherein the processor processes additional data received from at least one of the devices within the network.

4. The adapter of clause 1 wherein at least two of the devices implement disparate remote user interface protocols.

5. The adapter of clause 1 wherein the adapter is discoverable by the devices.

6. The adapter of clause 5 wherein discovering occurs by Universal Plug and Play.

7. The adapter of clause 1 wherein the application is incorporated as a middleware layer.

8. The adapter of clause 1 wherein the application receives a command in a first remote user interface protocol and sends the command in a second remote user interface protocol.

9. The adapter of clause 1 wherein the adapter is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

10. A method of implementing an adapter comprising:
a. discovering devices in a network;
b. determining a remote user interface protocol for each of the devices; and
c. enabling the devices to communicate using the remote user interface protocols.

11. The method of clause 10 further comprising performing additional processing to lessen a processing load on at least one of the devices in the network.

12. The method of clause 10 wherein enabling further comprises translating a command in a first remote user interface protocol into the command in a second remote user interface protocol.

13. The method of clause 12 wherein translating further comprises receiving a command in the first remote user interface protocol and sending the command in the second remote user interface protocol.

14. The method of clause 13 wherein the first remote user interface protocol is different from the second remote user interface protocol.

15. A network of devices comprising:
a. a first device implementing a first remote user interface protocol;
b. a second device implementing a second remote user interface protocol; and
c. an adapter device capable of communicating in the first remote user interface protocol and the second remote user interface protocol for converting commands received in the first user interface protocol to the second user interface protocol.

16. The network of devices of clause 15 wherein the first device is a gateway device and the second device is a rendering device.

17. The network of devices of clause 15 wherein the adapter device receives the commands in the first remote user interface protocol from the first device and communicates the commands in the second remote user interface protocol to the second device.

18. The network of devices of clause 15 wherein the first protocol and the second protocol are disparate protocols.

19. A system programmed in a controller in a device comprising
a. a discovering module for discovering devices in a network;
b. a determining module for determining a remote user interface protocol implemented by each of the devices; and
c. an adapting module for translating a command in a first remote user interface protocol to the command in a second remote user interface protocol.

20. The system of clause 19 wherein the devices are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications may be made in the embodiment chosen for illustration without departing from the spirit and scope of the invention as defined by the claims.

What is claimed is:

1. An adapter comprising:
a. a memory for storing an application, the application for:
i. determining remote user interface protocols implemented on devices within a network;
ii. enabling the devices to communicate using the remote user interface protocols; and
b. a processing component coupled to the memory, the processing component for processing the application.

2. The adapter of claim 1 wherein the application implements the remote user interface protocols.

3. The adapter of claim 1 wherein the processor processes additional data received from at least one of the devices within the network.

4. The adapter of claim 1 wherein at least two of the devices implement disparate remote user interface protocols.

5. The adapter of claim 1 wherein the adapter is discoverable by the devices.

6. The adapter of claim 5 wherein discovering occurs by Universal Plug and Play.

7. The adapter of claim 1 wherein the application is incorporated as a middleware layer.

8. The adapter of claim 1 wherein the application receives a command in a first remote user interface protocol and sends the command in a second remote user interface protocol.

9. The adapter of claim 1 wherein the adapter is selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.

10. A method of implementing an adapter comprising:
a. discovering devices in a network;
b. determining a remote user interface protocol for each of the devices; and
c. enabling the devices to communicate using the remote user interface protocols.

11. The method of claim 10 further comprising performing additional processing to lessen a processing load on at least one of the devices in the network.

12. The method of claim 10 wherein enabling further comprises translating a command in a first remote user interface protocol into the command in a second remote user interface protocol.

13. The method of claim 12 wherein translating further comprises receiving a command in the first remote user interface protocol and sending the command in the second remote user interface protocol.

14. The method of claim 13 wherein the first remote user interface protocol is different from the second remote user interface protocol.

15. A network of devices comprising:
a. a first device implementing a first remote user interface protocol;
b. a second device implementing a second remote user interface protocol; and
c. an adapter device capable of communicating in the first remote user interface protocol and the second remote user interface protocol for converting commands received in the first user interface protocol to the second user interface protocol.

16. The network of devices of claim 15 wherein the first device is a gateway device and the second device is a rendering device.

17. The network of devices of claim 15 wherein the adapter device receives the commands in the first remote user interface protocol from the first device and communicates the commands in the second remote user interface protocol to the second device.

18. The network of devices of claim 15 wherein the first protocol and the second protocol are disparate protocols.

19. A system programmed in a controller in a device comprising
a. a discovering module for discovering devices in a network;
b. a determining module for determining a remote user interface protocol implemented by each of the devices; and
c. an adapting module for translating a command in a first remote user interface protocol to the command in a second remote user interface protocol.

20. The system of claim 19 wherein the devices are selected from the group consisting of a personal computer, a laptop computer, a computer workstation, a server, a mainframe computer, a handheld computer, a personal digital assistant, a cellular/mobile telephone, a smart appliance, a gaming console, a digital camera, a digital camcorder, a camera phone, an iPhone, an iPod®, a video player, a DVD writer/player, a television, a home entertainment system and an intelligent appliance.
